(19) United States
(12) Patent Application Publication
(10) Pub. No.: US 2007/0002153 A1
(43) Pub. Date: Jan. 4, 2007

(54) Hue preservation

(76) Inventor: Bart Dierickx, Edegem (BE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/172,072

(22) Filed: Jun. 29, 2005

(51) Int. Cl. H04N 9/04

(52) U.S. Cl. 348/272

(57) ABSTRACT

A method and apparatus for hue preservation under digital exposure control by preserving color component ratios on a pixel by pixel basis.

### TECHNICAL FIELD

The present invention relates generally to an image sensor and, more particularly, to preserving hue in an image sensor.

### BACKGROUND

Solid-state image sensors have found widespread use in camera systems. The solid-state image sensors in some camera systems are composed of a matrix of photosensitive elements in series with amplifying and switching components. The photosensitive elements may be, for example, photo-diodes, phototransistors, charge-coupled devices (CCDs), or the like. Typically, a lens is used to focus an image on an array of photosensitive elements, such that each photosensitive element in the array receives light (photons) from a portion of the focused image. Each photosensitive element (picture element, or pixel) converts a portion of the light it absorbs into electron-hole pairs and produces a charge or current that is proportional to the intensity of the light it receives. A pixel with integrated amplifying components is called an active pixel. In some image sensor technologies, notably CMOS (complementary metal oxide semiconductor) fabrication processes, an array of pixels can be fabricated with integrated amplifying and switching devices in a single integrated circuit chip. A pixel with integrated electronics is known as an active pixel. A passive pixel, on the other hand, requires external electronics to provide charge buffering and amplification. In either case, each pixel in the array produces an electrical signal indicative of the light intensity of the image at the location of the pixel.

The pixels in image sensors that are used for light photography are inherently panchromatic. They respond to a broad band of electromagnetic wavelengths that include the entire visible spectrum as well as portions of the infrared and ultraviolet bands. In addition, the shape of the response curve in the visible spectrum differs from the response of the human eye. To produce a color image, a color filter array (CFA) is located between the light source and the pixel array. The CFA may be an array of red (R), green (G) and blue (B) filters, one filter covering each pixel in the pixel array in a certain pattern.

The most common pattern for a CFA is a mosaic pattern called the Bayer pattern. The Bayer pattern consists of rows (or columns) of alternating G and R filters, alternating with rows (or columns) of alternating B and G filters. The Bayer pattern produces groupings of four neighboring pixels made up of two green pixels, a red pixel and a blue pixel, which together may be treated as a “color cell” with red, green and blue color signal components. Red, green and blue are primary colors which can be combined in different proportions to reproduce all common colors. The native signal from each pixel corresponds to a single color channel. In a subsequent operation known as “demosaicing,” the color signals from neighboring pixels are interpolated to provide estimates of the missing colors at each pixel. Thus, each pixel is associated with one native color signal and two estimated (attributed) color signals (e.g., in the case of a three color system). Additional processing may be required to ensure that the RGB output signals associated with each pixel match the RGB values of the physical object. In general, this color adjustment operation also includes white balancing and color saturation corrections. Typically, the operations are carried out in the digital domain (following analog-to-digital conversion as described below) using matrix processing techniques, and are referred to as “matrixing.”

CFA's can also be made with complementary color filters (e.g., cyan, magenta and yellow) and can have a variety of configurations including other mosaic patterns and horizontal, vertical or diagonal striped patterns (e.g., alternating rows, columns or diagonals of a single color filter).

After some analog signal processing, which may include fixed-pattern noise (FPN) cancellation the raw signal of each pixel is sent to an analog-to-digital converter (ADC). The output of the ADC is a data word with a value corresponding to the amplitude of the pixel signal. To provide processing headroom, the dynamic range of the ADC and any subsequent digital processing hardware is usually greater than the dynamic range from each pixel. In many camera systems, brightness is controlled by applying digital gain or attenuation to the digitized data in the R, G and B channels, either as part of an automatic exposure/gain-control loop, or manually from the user. The gain or attenuation is achieved by digital multiplication or division. For example, binary data may be multiplied or divided by powers of 2 by shifting the digitized data toward the most significant bit in a data register for multiplication or toward the least significant bit for division. Other methods of digital multiplication and division, including floating point operations, are known in the art. After digital gain is applied, the data is truncated (“clipped”) to the number of bits corresponding to the bit-resolution that is required for the final digital image.

If portions of a digital image are brightly illuminated, one or more of the color signals from a pixel may be at or near (or even beyond) its saturation level, and the signal may exceed the saturation value after digital gain is applied. As a result, the signal may be dipped by the digital truncation process, and the correct ratios between the color signals (R::G::B) will be lost. The hue of an image derived from the data will be distorted because the hue depends on the ratios among the color signals. FIGS. 1A through 1C illustrate the hue distortion problem. In FIG. 1A, red, green and blue pixel data is stored in 12 bit registers, where it is assumed that the raw data originally have 10 bits. In the example shown, the ratios R::G::B are 16.5::4.1::1.0. FIG. 1B illustrates the data values after a multiplication by 4 (e.g., a 2-bit shift), where the ratios are preserved by the headroom of the 12-bit registers over the 10 bit data. FIG. 1C illustrates the effect of truncation (clipping) back to 10 bits after the digital gain is applied, where the ratios R::G::B have been changed to 8.3::4.1::1.0.

FIG. 2 is a color image that illustrates the effects of clipping when conventional digital gain and truncation causes data loss. In FIG. 2, the bar chart below the image represents the R, G and B color levels in the over-illuminated regions of the original image (e.g., cheeks, nose, chin and shoulder areas of the model), where the red and green components have been clipped as a result of applying digital gain and truncation to all three components. At moderate clipping levels, the flesh tones of the model are distorted because the proportions of the blue and green signals are increased relative to the red signal. At clipping levels where red and green are both saturated, the flesh tones will appear jaundiced because equal portions of red and green combine to make yellow. In a grey scale reproduction of the image, the effect can be seen as a bleaching of the affected areas of the image. In the limit, as digital gain is increased further, all the color component signals from a color pixel will be clipped at the maximum level. When this happens, the pixel will appear pure white because equal levels of red, green and blue produce white (the same effect will occur regardless of which primary or complementary color scheme is used).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention is illustrated by way of example, and not by way of limitation, in the figures of the accompanying drawings in which:

FIGS. 1A-1C illustrate conventional digital image processing.

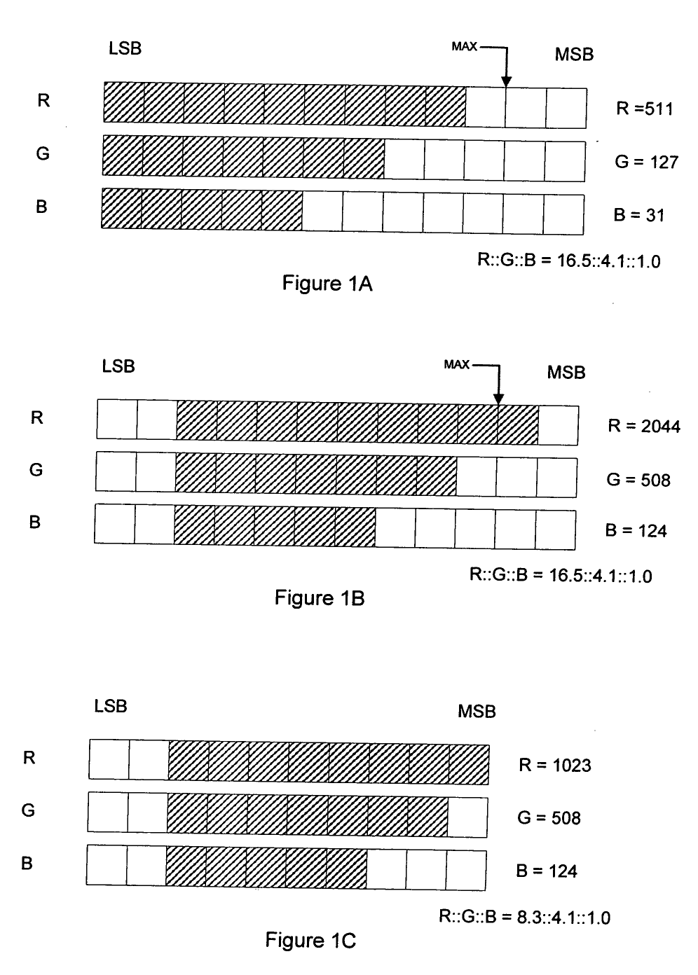

FIG. 2 illustrates hue distortion in a conventional imaging system.

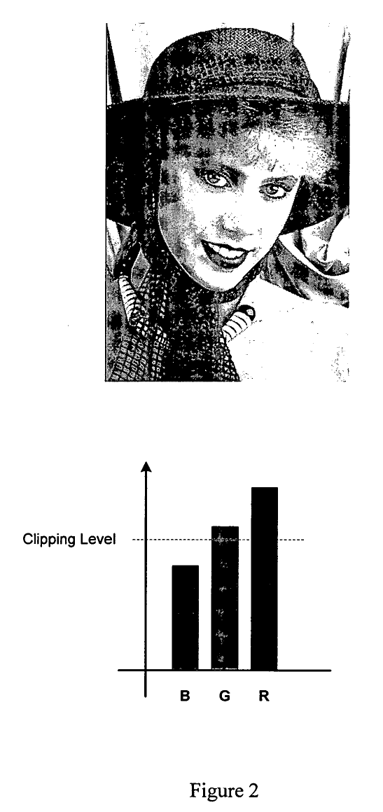

FIG. 3 illustrates one embodiment of a method of hue preservation

FIG. 4 illustrates an image sensor in one embodiment of hue preservation.

FIGS. 5A and 5B illustrate color interpolation in one embodiment of hue preservation.

FIG. 6 illustrates one embodiment of hue preservation

FIG. 7 illustrates one embodiment of a method of hue preservation.

FIGS. 8A-8C illustrate hue preservation in a digital image.

### DETAILED DESCRIPTION

In the following description, numerous specific details are set forth, such as examples of specific commands, named components, connections, data structures, etc., in order to provide a thorough understanding of embodiments of the present invention. It will be apparent, however, to one skilled in the art that embodiments of present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Embodiments of the present invention include circuits, to be described below, which perform operations. Alternatively, the operations of the present invention may be embodied in machine-executable instructions, which may be used to cause a general-purpose or special-purpose processor programmed with the instructions to perform the operations. Alternatively, the operations may be performed by a combination of hardware and software.

Embodiments of the present invention may be provided as a computer program product, or software, that may include a machine-readable medium having stored thereon instructions, which may be used to program a computer system (or other electronic devices) to perform a process according to the present invention. A machine readable medium includes any mechanism for storing or transmitting information in a form (e.g., software, processing application) readable by a machine (e.g., a computer). The machine readable medium may include, but is not limited to: magnetic storage media (e.g., floppy diskette); optical storage media (e.g., CD-ROM); magneto-optical storage media; read only memory (ROM); random access memory (RAM); erasable programmable memory (e.g., EPROM and EEPROM); flash memory; electrical, optical, acoustical or other form of propagated signal; (e.g., carrier waves, infrared signals, digital signals, etc.); or other type of medium suitable for storing electronic instructions.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

The term “coupled to” as used herein may mean coupled directly to or indirectly to through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines, and each of the single signal lines may alternatively be buses.

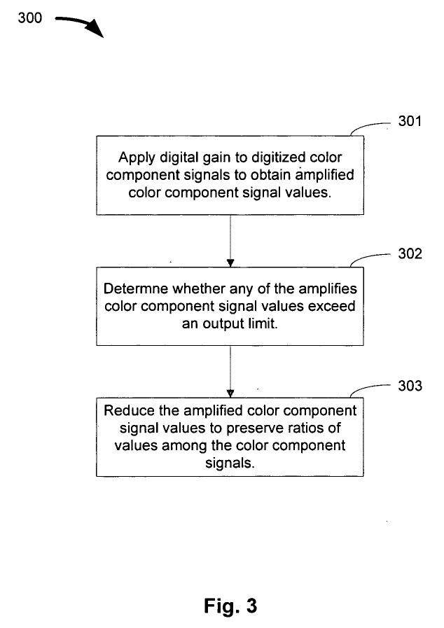

A method and apparatus for hue preservation in an image sensor is described. In one embodiment, as illustrated in FIG. 3, a method 300 for hue preservation includes: acquiring color component signals from pixels in a photoelectric device, where ratios among the color component signals correspond to hues in an illuminated image; detecting over-illumination capable of distorting the hues, on a pixel-by-pixel basis; and preserving the ratios among the color component signals while correcting the over-illumination on a pixel-by-pixel basis.

In one embodiment, an apparatus for hue preservation includes an analog to digital converter (ADC) to receive electrical signals from a photoelectric device and to generate digital signals, each of the digital signals having a value proportional to a color component of light incident on the photoelectric device. The apparatus further includes a signal processor coupled to the ADC to receive the digital signals, apply gain to the digital signals to obtain brightness corrected digital signals, to determine whether any of the brightness corrected digital signals exceeds an output limit, and to reduce the brightness corrected digital signals to preserve ratios of values among the digital signals.

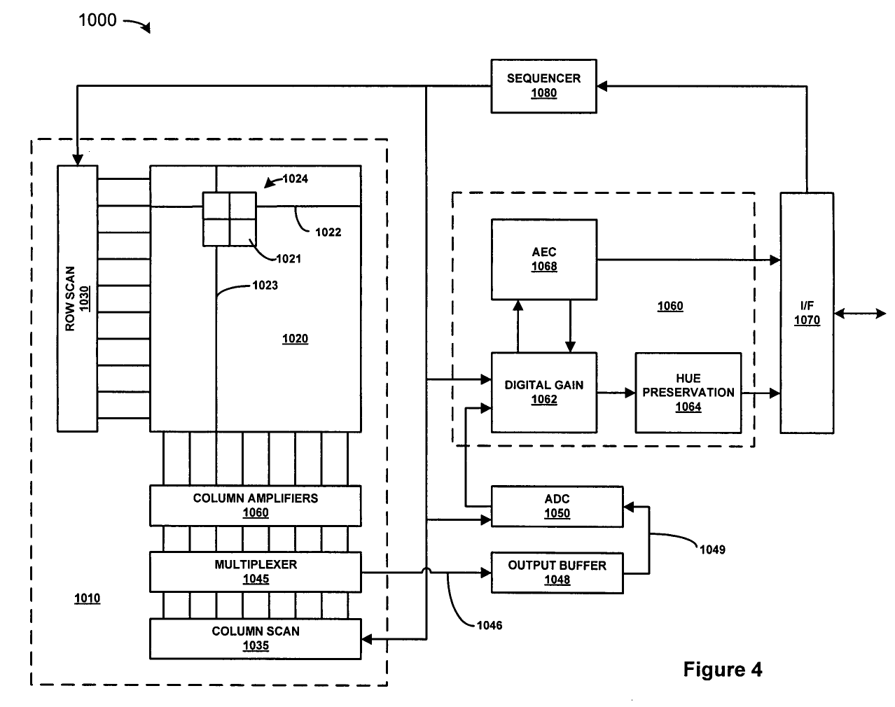

FIG. 4 illustrates one embodiment of an image sensor including hue preservation. Image sensor 1000 includes a pixel array 1020 and electronic components associated with the operation of an imaging core 1010 (imaging electronics). In one embodiment, the imaging core 1010 includes a pixel matrix 1020 having an array of color pixels (e.g., pixel 1021), grouped into color cells (e.g., color cell 1024) and the corresponding driving and sensing circuitry for the pixel matrix 1020. The driving and sensing circuitry may include: one or more row scanning registers 1030 and one or more column scanning registers 1035 in the form of shift registers or addressing registers; column amplifiers 1040 that may also contain fixed pattern noise (FPN) cancellation and double sampling circuitry; and an analog multiplexer (mux) 1045 coupled to an output bus 1046.

The pixel matrix 1020 may be arranged in M rows of pixels (having a width dimension) by N columns of pixels (having a length dimension) with N≧1 and M≧1. Each pixel (e.g., pixel 1021) is composed of at least a color filter (e.g., red, green or blue), a photosensitive element and a readout switch (not shown). Pixels in pixel matrix 1020 may be grouped in color patterns to produce color component signals (e.g., RGB signals) which may be processed together as a color cell (e.g., color cell 1024) to preserve hue as described below. Pixels of pixel matrix 1020 may be linear response pixels (i.e., having linear or piecewise linear slopes). In one embodiment, pixels as described in U.S. Pat. No. 6,225,670 may be used for pixel matrix 1020. Alternatively, other types of pixels may be used for pixel matrix 1020. A pixel matrix is known in the art; accordingly, a more detailed description is not provided.

The row scanning register(s) 1030 addresses all pixels of a row (e.g., row 1022) of the pixel matrix 1020 to be read out, whereby all selected switching elements of pixels of the selected row are closed at the same time. Therefore, each of the selected pixels places a signal on a vertical output line (e.g., line 1023), where it is amplified in the column amplifiers 1040. Column amplifiers 1040 may be, for example, transimpedance amplifiers to convert charge to voltage. In one embodiment, column scanning register(s) 1035 provides control signals to the analog multiplexer 1045 to place an output signal of the column amplifiers 1040 onto output bus 1046 in a column serial sequence. Alternatively, column scanning register 1035 may provide control signals to the analog multiplexer 1045 to place more than one output signal of the column amplifiers 1040 onto the output bus 1046 in a column parallel sequence. The output bus 1046 may be coupled to an output buffer 1048 that provides an analog output 1049 from the imaging core 1010. Buffer 1048 may also represent an amplifier if an amplified output signal from imaging core 1010 is desired.

The output 1049 from the imaging core 1010 is coupled to an analog-to-digital converter (ADC) 1050 to convert the analog imaging core output 1049 into the digital domain. The ADC 1050 is coupled to a digital processing device 1060 to process the digital data received from the ADC 1050. As described below in greater detail, the digital processing device 1060 may include a digital gain module 1062, a hue preservation module 1064, and an automatic exposure and gain control module 1066. Digital processing device 1060 may be one or more general-purpose processing devices such as a microprocessor or central processing unit, a controller, or the like. Alternatively, digital processing device 1060 may include one or more special-purpose processing devices such as a digital signal processor (DSP), an application specific integrated circuit (ASIC), a field programmable gate array (FPGA), or the like. Digital processing device 1060 may also include any combination of a general-purpose processing device and a special-purpose processing device.

The digital processing device 1060 may be coupled to an interface module 1070 that handles the information input/output exchange with components external to the image sensor 1000 and takes care of other tasks such as protocols, handshaking, voltage conversions, etc. The interface module 1070 may be coupled to a sequencer 1080. The sequencer 1080 may be coupled to one or more components in the image sensor 1000 such as the imaging core 1010, digital processing device 1060, and ADC 1050. The sequencer 1080 may be a digital circuit that receives externally generated clock and control signals from the interface module 1070 and generates internal pulses to drive circuitry in the imaging sensor (e.g., the imaging core 1010, ADC 1050, etc.).

The image sensor 1000 may be fabricated on one or more common integrated circuit die that may be packaged in a common carrier. In one embodiment, one or more of digital processing device 1060 are disposed on the integrated circuit die outside the imaging area (i.e., pixel matrix 1020) on one or more integrated circuit die of the image sensor 1000.

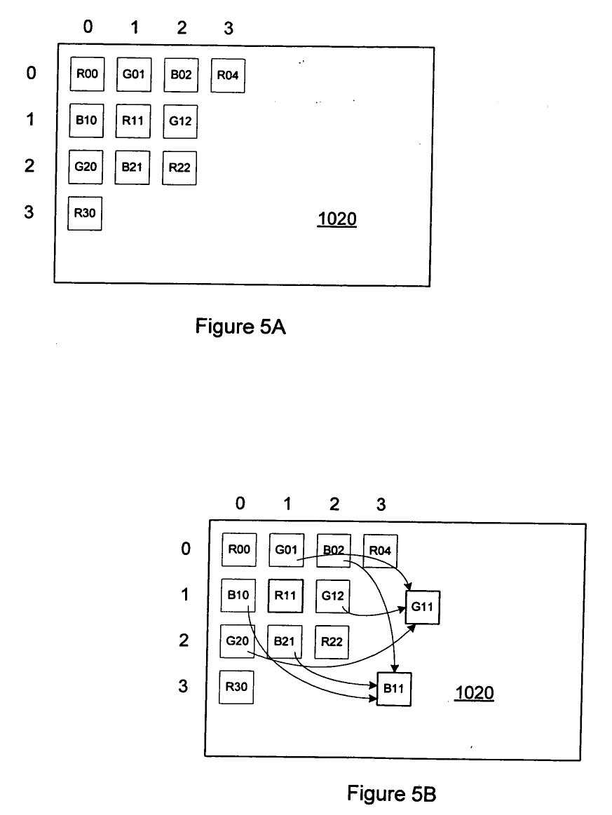

FIGS. 5A and 5B illustrate how data from pixel matrix 1020 may be processed to collect data from related color pixels for hue preservation. In FIG. 5A, a portion of pixel matrix 1020 is illustrated with, for example, a diagonal stripe CFA pattern where the columns and rows of the matrix are labeled 0, 1, 2, etc. Each pixel may be identified by its matrix coordinates and associated with adjacent pixels to obtain interpolated estimates of the color components missing from each individual pixel. One example of this process is illustrated symbolically in FIG. 5B, where an interpolated G₁₁ component for pixel R₁₁ is derived from neighbor pixels G₀₁, G₁₂ and G₂₀ (e.g., by averaging the values). Similarly, an interpolated B₁₁ component for pixel R₁₁ may be derived from neighbor pixels B₀₂, B₁₀ and B₂₁. The three components then define the effective hue of pixel R₁₁ with respect to subsequent processing and hue preservation. Other color estimation and interpolation methods, as are known in the art, may also be used to derive color component signals for each pixel in pixel matrix 1020.

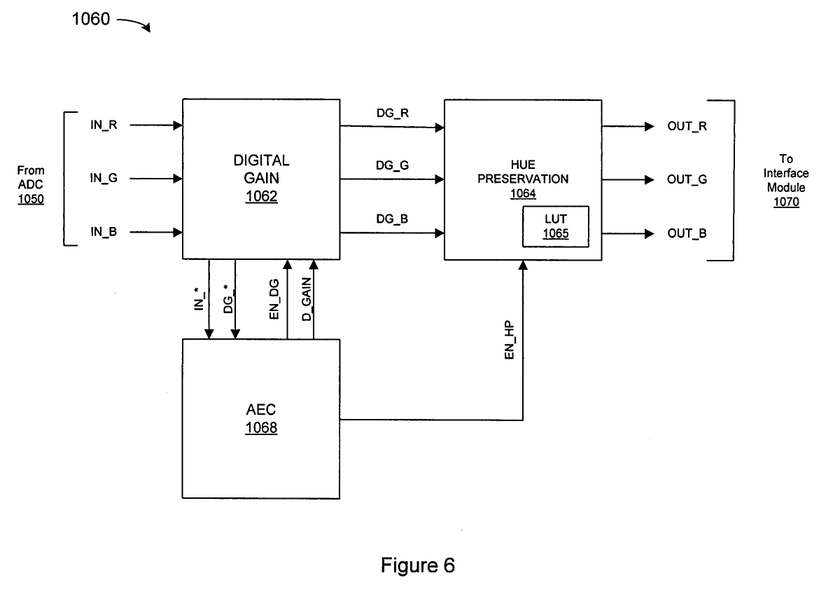

FIG. 6 illustrates one embodiment of digital processing device 1060 including hue preservation. Digital processing device 1060 is described below in the context of an RGB color component system for convenience and clarity of description. It will be appreciated that digital processing device 1060 may also have embodiments in non-RGB color component systems and in systems with more than three colors. In this embodiment, AEC module 1068 executes an exposure control algorithm that determines a gain factor to be multiplied with all incoming pixel data from ADC 1050.

If digital gain is not required, then the digital gain factor defaults to 1 and the color component values are passed directly from AEC 1068 to the interface module 1070 on output lines AEC_OUT_R, AEC_OUT_G, and AEC_OUT B (generically AEC_OUT_*).

If digital gain is required, AEC module 1068 sends an enable digital gain command (EN_DG) to digital gain module 1062, as well as a digital gain factor (D_GAIN). If digital gain is enabled, then the color components from ADC 1050, inputs IN_R, IN_G, and IN_B to digital gain module 1062 (generically IN_*), are multiplied by the digital gain factor. As noted above, the digital channels in digital processing device 1060 may have bit depths greater than the depth required for the largest (e.g., saturated) pixel output, in order to accommodate digital gain without register overflow. For example, if the maximum pixel output value (MAX) can be coded in n bits (i.e., MAX=2ⁿ), then the internal bit depth of digital processing device 1060 may be n+m, such that digital processing device may manipulate data values 2^{m} times greater than MAX.

As noted above, the gain factor applied to the output of ADC 1050 may be less than unity (i.e., attenuation) This may be the case, for example, when the number of bits coming from the ADC exceeds those of the required number of useful bits in the output after image processing. For example, ADC 1050 may yield 10 bits (LARGEST_DG=1023), while the final image is coded with 8 bits (MAX=255). In such a case, the most significant bits may be truncated (clipped) in the same way as described for gains greater than unity.

If digital gain is enabled, AEC module 1068 reads each of the multiplied outputs DG_* to determine whether any of the outputs DG_* is greater than a specified maximum value (MAX), which, as noted above, may be the saturation value of a pixel before digital multiplication, or, alternatively, a maximum value that digital processing device 1060 is designed to supply to interface module 1070.

If any of the multiplied outputs DG_* exceeds the maximum value, then AEC module 1068 enables hue preservation for the current color cell by sending an enable hue preservation command (EN_HP) to the hue preservation module 1064.

If hue preservation is enabled, the hue preservation module 1064 determines which of the DG_* values is the largest value (LARGEST_DG_*) and normalizes all of the DG_* values to the largest value by dividing each DG_* value by the largest value to obtain normalized values dg_*, such that
dg_*=(DG_*)/(LARGEST_{—}DG_*) [eqn. 1]

For example, if DG_R is the largest value, then hue preservation module calculates:
dg_{—}r=(DG_{—}R)/(DG_{—}R) [eqn. 2]
dg_{—}g=(DG_{—}G)/(DG_{—}R) [eqn. 3]
dg_{—}b=(DG_{—}B)/(DG_{—}R) [eqn. 4]

Hue preservation module 1064 then scales each of the normalized values dg_* to an intermediate hue preserved value HP_* (not shown) by multiplying each dg_* value by the specified maximum value MAX, such that the largest signal is scaled to MAX and the other signals are scaled to values less than MAX. Continuing the example from above:
HP_{—}R=(dg_{—}r)×(MAX) [eqn. 5]
HP_{—}G=(dg_{—}g)×(MAX) [eqn. 6]
HP_{—}B=(dg_{—}b)×(MAX) [eqn. 7]

It will be appreciated that the order of the above described operations may be altered. For example, the signal values may be scaled first and then normalized. Alternatively, a combined scaling and normalization factor (e.g., MAX/LARGEST_DG) may be calculated and then applied to the values DG_*.

The maximum value of any HP_* signal will be limited to the value of MAX (except for possible rounding errors, described below). Therefore, the normalized and scaled values HP_* may be output to interface module 1070 as output values OUT_* with truncated word lengths of corresponding to the value MAX.

With respect to the foregoing description, it will be appreciated that the value of LARGEST_DG may be an arbitrary digital value determined by the value of an analog input to ADC 1050. In particular, the value of LARGEST_DG may not be a power of 2 and. therefore, multiplying every DG_* by the factor (MAX)/(LARGEST_DG) may be computationally awkward in a digital system such as digital processing device 1060. In one embodiment, therefore, hue preservation module 1064 may include a lookup table (LUT) 1065 as illustrated in FIG. 6. LUT 1065 may be, for example, data stored in a memory in digital processing device 1060. Table 1 below illustrates an example of a lookup table. In the exemplary embodiment of Table 1, a saturated pixel output value MAX may be 1023, corresponding to a 10-bit output signal OUT_*. The digital processing channels in digital processing device 1060 may be [12.2] bit channels (12 bit characteristic, 2 bit mantissa) capable of registering data values value from 0 to 4095.75. In Table 1, values in LUT are encoded as [0.10] values (10 bit mantissa). The lookup table includes the factor MAX/LARGEST_DG for 9 different values of LARGEST_DG ranging from 1024 to 2048. The same table may be used for values of LARGEST_DG ranging from 2048 to 4095 by calculating the index on different bits and dividing the values in the LUT by 2 (1-bit shift). LARGEST_DG is compared with the numbers in the LUT to determine an interval where linear interpolation may be used. Interpolation may be done, for example, using 128 steps. Linear interpolation methods are known in the art and, accordingly, are not described in detail.

TABLE 1

| INDEX (i) | LARGEST_DG | MAX/LARGEST_DG | LUT (i) [0.10] |
|---|---|---|---|
| 1 | 1024 | 0.999 | “1111111111” |
| 2 | 1152 | 0.888 | “1110001110” |
| 3 | 1280 | 0.799 | “1100110011” |
| 4 | 1408 | 0.727 | “1011101000” |
| 5 | 1536 | 0.666 | “1010101010” |
| 6 | 1664 | 0.615 | “1001110110” |
| 7 | 1792 | 0.571 | “1001001001” |
| 8 | 1920 | 0.533 | “1000100010” |
| 9 | 2048 | 0.500 | “1000000000” |

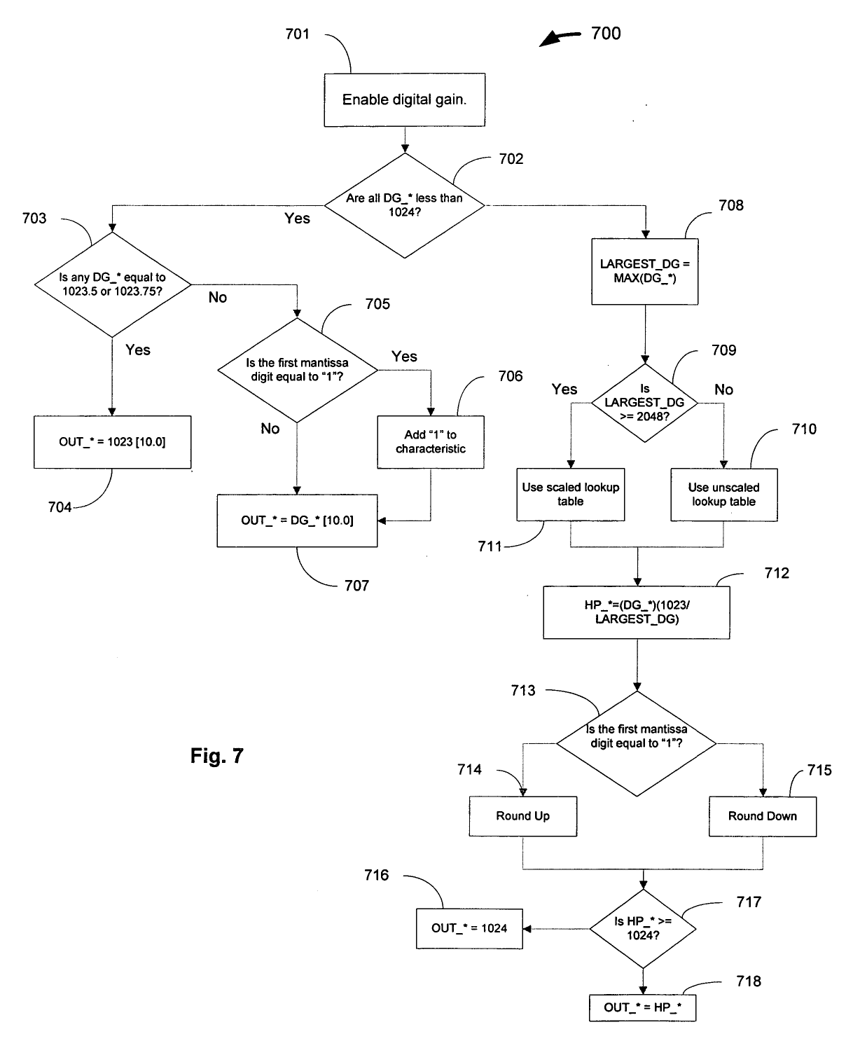

Thus, in one exemplary embodiment of a method of hue preservation, as illustrated in FIG. 7, the method 700 begins when AEC module 1068 enables digital gain in digital gain module 1062 to obtain digitally amplified signals DG_* (step 701). Next, AEC module 1068 determines if all signals DG_* are less than 1024 (step 702). If all signals DG_* are less than 1024, then AEC module 1068 checks if any signal DG_* is either 1023.5 or 1023.75 (step 703). Any signal DG_* that is either 1023.5 or 1023.73 is truncated to a [10.0] formatted 1023 and outputted to interface module 1070 as an OUT_* signal (step 704). For any DG_* signal that is less than 1024 and not equal to 1023.5 or 1023.75, AEC module 1068 checks the value of the first bit of the mantissa (step 705). If the first bit of the mantissa 1 (i.e., 0.5 decimal), the value is rounded up to the next integer value (1 is added to the characteristic) (step 706), and the value is truncated to a [10.0] bit format and outputted to interface module 1070 as an OUT_* signal (step 707). If the first bit of the mantissa is 0 at step 605, the value is truncated to a [10.0] bit format (i.e., rounded down) and outputted to interface module 1070 as an OUT_* signal (step 707).

If, at step 702, all of the DG_* signals are not less than 1024, then the largest value of DG_* is assigned to LARGEST_DG (step 708). Next, it is determined if LARGEST_DG is greater than or equal to 2048 (step 709). If LARGEST_DG is less than 2048, a lookup table index and interpolation factor are computed using the unscaled lookup LUT (step 710). If LARGEST_DG is greater than or equal to 2048, a lookup table index and interpolation factor are computed using a scaled lookup table LUT/2 (step 711). Next, each DG_* signal is multiplied by the interpolated factor (MAX)/(LARGEST_DG) to obtained hue preserved signals HP_* in [12.2] bit format (step 712). Next, the first bit in the mantissa of each HP_*value is tested (step 713). If the first bit in the mantissa is 1, the value of HP_* is rounded up to a [12.0] bit format (step 714). If the first bit in the mantissa is a 0, the value of HP_* is rounded down to a [12.0] bit format (step 715). Finally, each value of HP_* is truncated to a [10.0] bit format and passed to interface module 1070 as an OUT_* signal (step 716).

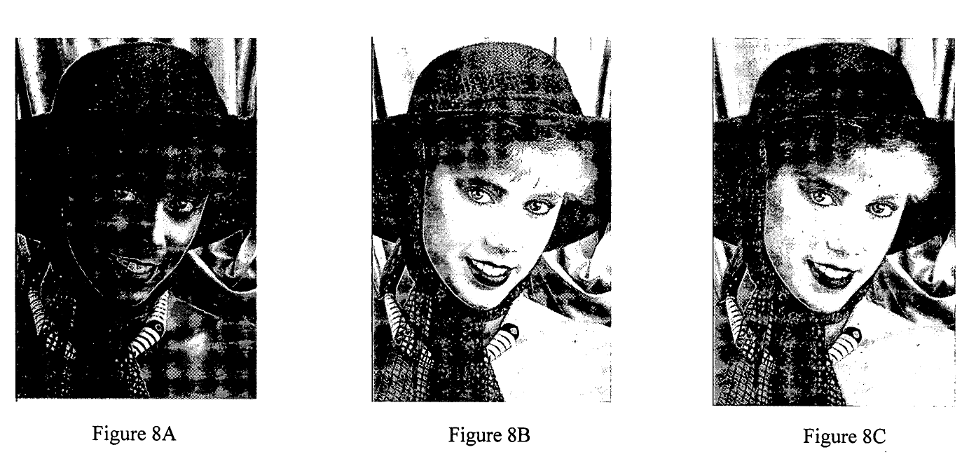

FIGS. 8A-8C illustrate the effect of hue preservation. FIG. 8A illustrates an original image, with regions of over-illumination before digital gain is applied. FIG. 8B represents an image produced with conventional image processing without hue preservation, and FIG. 8C represents an image processed with hue preservation according to embodiments of the present invention.

The image sensor 1000 discussed herein may be used in various applications. In one embodiment, the image sensor 1000 discussed herein may be used in a digital camera system, for example, for general-purpose photography (e.g., camera phone, still camera, video camera) or special-purpose photography. Alternatively, the image sensor 1000 discussed herein may be used in other types of applications, for example, machine vision, document scanning, microscopy, security, biometry, etc.

While some specific embodiments of the invention have been shown the invention is not to be limited to these embodiments. The invention is to be understood as not limited by the specific embodiments described herein, but only by scope of the appended claims.

What is claimed is:

1. A method, comprising:
acquiring a plurality of color component signals from pixels in a photoelectric device, wherein ratios among the plurality of color component signals correspond to hues of an illuminated image;
detecting over-illumination capable of distorting the hues, on a pixel-by-pixel basis; and
preserving the ratios among the color component signals while correcting the over-illumination on a pixel-by-pixel basis.

2. The method of claim 1, wherein detecting over-illumination comprises:
applying gain to the plurality of color component signals to obtain a plurality of gain-adjusted color component signals, each of the plurality of gain-adjusted color component signals having an amplitude in proportion to a color component of light incident on a color pixel; and
determining whether one or more of the plurality of gain-adjusted color component signals exceeds a threshold value.

3. The method of claim 2, wherein the gain is one of unity gain, less than unity gain, and greater than unity gain on a pixel-by-pixel basis.

4. The method of claim 2, wherein each color component signal is limited to a range of values between zero and a maximum value corresponding to a clipping level.

5. The method of claim 2, wherein determining whether one or more of the plurality of color component signals exceeds a threshold value comprises comparing each gain-adjusted color component signal with the maximum value.

6. The method of claim 2, wherein preserving the ratios among the color component signals:
normalizing each gain-adjusted color component signal to a largest one of the plurality of gain-adjusted color component signals to obtain a plurality of normalized color component signals; and
scaling the plurality of normalized color component signals.

7. The method of claim 6, wherein normalizing each gain-adjusted color component signal to a largest one of the plurality of gain-adjusted color component signals comprises dividing each gain-adjusted color component signal by the largest one of the plurality of gain-adjusted color component signals.

8. The method of claim 6, wherein scaling the plurality of normalized color component signals comprises multiplying each normalized color component signal by the maximum value.

9. The method of claim 2, wherein determining whether one or more of the plurality of color component signals exceeds a threshold value comprises comparing each gain-adjusted color component signal with the threshold value.

10. The method of claim 2, wherein preserving the ratios among the color component signals while correcting the over-illumination comprises:
accessing a lookup table with an index derived from a largest one of the plurality of gain-adjusted color component signals;
interpolating a scaling parameter from the lookup table; and
multiplying the plurality of gain-adjusted color component signals with the scaling parameter.

11. The method of claim 1, wherein each color component signal corresponds to one of a plurality of primary colors.

12. The method of claim 1, wherein each color component signal corresponds to one of a plurality of complementary colors.

13. An article of manufacture, comprising a machine-accessible medium including data that, when accessed by a machine, cause the machine to perform operations comprising the method of claim 1.

14. An apparatus, comprising:
an analog-to-digital converter (ADC) to receive a plurality of electrical signals from a photoelectric device, the ADC to generate a corresponding plurality of digital signals, each digital signal having a value proportional to a color component of light incident on the photoelectric device; and
a signal processor coupled to the ADC to receive the plurality of digital signals, to apply gain to the plurality of digital signals to obtain brightness adjusted digital signals, to determine whether one or more of the brightness adjusted digital signals exceeds an output limit, and to reduce the brightness adjusted digital signals to preserve ratios of values of the plurality digital signals.

15. The apparatus of claim 14, wherein each digital signal is limited to a range of values between zero and a maximum value corresponding to a digital clipping level.

16. The apparatus of claim 15, the signal processor further to multiply each digital signal by a programmable coefficient to generate the plurality of brightness adjusted digital signals, and to compare each brightness adjusted digital signal with the maximum value.

17. The apparatus of claim 16, the signal processor further to divide each brightness adjusted digital signal by a largest one of the plurality of brightness adjusted digital signals to obtain a plurality of normalized digital signals, and to multiply each normalized digital signal by the maximum value.

18. An article of manufacture, comprising a machine-accessible medium including data that, when accessed by a machine, cause the machine to perform operations comprising a method, the method comprising:
acquiring color components from pixels of a digital image, each color component having a range from zero to a maximum value;
multiplying each color component by a common factor to obtain a plurality of amplified color components;
determining that one or more of the amplified color components is greater than the maximum value; and
replacing each amplified color component with a corrected color component.

19. The article of manufacture of claim 18, wherein replacing each amplified color component with a corrected color component comprises:
dividing each color component by a largest one of the color components; and
multiplying each color component by the maximum value.

20. The article of manufacture of claim 18, wherein replacing each amplified color component with a corrected color component comprises:
accessing a lookup table with an index derived from a largest one of the plurality of amplified color component signals;
interpolating a scaling parameter from the lookup table; and
multiplying the plurality of amplified color component signals with the scaling parameter.
